(19) United States
(12) Patent Application Publication
(10) Pub. No.: US 2026/0004305 A1
(43) Pub. Date: Jan. 1, 2026

(54) METHODS AND SYSTEMS FOR CATEGORIZING PAYMENT CARDS FOR FRAUD PREVENTION

(71) Applicant: MASTERCARD INTERNATIONAL INCORPORATED, Purchase, NY (US)

(72) Inventors: Bhargav Pandillapalli, Atmakur (IN); FNU Karamjit Singh, Harrison, NY (US); Kamna Meena, New Delhi (IN); Liyana Sahir K, Kannur (IN); Nitish Kumar, Jamshedpur (IN); Siddhartha Asthana, New Delhi (IN)

(73) Assignee: MASTERCARD INTERNATIONAL INCORPORATED, Purchase, NY (US)

(21) Appl. No.: 19/256,993

(22) Filed: Jul. 1, 2025

(30) Foreign Application Priority Data
Jul. 1, 2024 (IN) 202441050342

(51) Int. Cl. G06Q 20/40; G06Q 20/34

(52) U.S. Cl. CPC G06Q 20/4016; G06Q 20/34

(57) ABSTRACT

Methods and server systems for categorizing payment cards for fraud prevention are described herein. Method performed by a server system includes accessing a card candidate set including relevant payment card(s), each payment card of the relevant payment card(s) being associated with multiple features. Method includes segregating the features into a set of risk-related features and a set of transactional features. Method further includes generating, by Machine Learning (ML) model(s), a riskiness score for each payment card based on the set of risk-related features. Method includes performing for each payment card: assigning a risk category based on the riskiness score and risk categorization criteria, and assigning a transactional category based on the set of transactional features and transaction behavior criteria. Method includes generating a recommendation message for an issuer based on the risk category and the transactional category.

### TECHNICAL FIELD

The present disclosure relates to a field of artificial intelligence-based processing systems and, more particularly, to electronic methods and complex processing systems for categorizing payment cards for fraud prevention.

### BACKGROUND

In an evolving finance landscape, financial frauds are also evolving to become more complex to detect and prevent. Financial fraud refers to deceptive activities aimed at gaining an unfair financial advantage, often resulting in financial losses for individuals, businesses, or financial institutions. Fraud can be broadly classified into three categories, i.e., card-related frauds, merchant-related frauds, and internet frauds. Card-related frauds include application frauds, lost/stolen card frauds, account takeovers, fake and counterfeit frauds, and the like. Merchant-related frauds include merchant collusion, triangulation, and the like. Internet frauds include site cloning, false merchant sites, credit card generators, and the like.

It is to be noted that businesses such as merchants and financial institutions, such as issuers and/or acquirers, are significantly more vulnerable than individuals such as cardholders. For example, while cardholders are concerned about getting the fraudulent charge reversed, merchants lose the cost of the product sold, pay chargeback fees, lose reputation, face loss due to good faith write-offs, fear having their merchant account closed, and many more additional risks. Financial institutions also bear the costs of fraud in many instances. Thus, the merchants and the financial institutions need techniques that can detect such fraud, so that they can take preventive measures to prevent the occurrence of such fraudulent activities.

As a result, multiple approaches have been implemented for fraud detection, varying from simple rule-based approaches to complex Neural Network (NN)-based approaches. Generally, most of these conventional approaches involve providing risk scores. The merchants and/or the financial institutions assess such risk scores and take actionable decisions to prevent fraud. However, the risk scores may not be accurate and generate several false positives. Moreover, deciding on preventive measures based on the type of risk and the level of riskiness requires a good amount of effort. Hence, it can be resource-intensive and time-consuming, leading to decisions that might not be efficient enough for fraud detection and prevention.

Thus, a technological need exists for improved methods and systems for categorizing payment cards for fraud prevention that are also associated with categorization reasoning, casing recommendations of remedial actions.

### SUMMARY

Various embodiments of the present disclosure provide methods and systems for categorizing payment cards for fraud prevention.

In an embodiment, a computer-implemented method for categorizing payment cards for fraud prevention is disclosed. The computer-implemented method performed by a server system includes accessing a card candidate set from a database associated with the server system. The card candidate set includes one or more relevant payment cards of a plurality of payment cards. Each payment card of the one or more relevant payment cards is associated with a plurality of features. The computer-implemented method further includes segregating the plurality of features into a set of risk-related features and a set of transactional features. Further, the computer-implemented method includes generating, by a set of Machine Learning (ML) models associated with the server system, a riskiness score corresponding to each payment card of the card candidate set based, at least in part, on the set of risk-related features. Furthermore, the computer-implemented method includes performing for each payment card: assigning a particular risk category of one or more risk categories based, at least in part, on the riskiness score and risk categorization criteria; and assigning a particular transactional category of one or more transactional categories based, at least in part, on the set of transactional features and transaction behavior criteria. Thereafter, the computer-implemented method includes generating a recommendation message for an issuer based, at least in part, on the risk category and the transactional category assigned to each payment card. The recommendation message is indicative of a remedial action that the issuer needs to perform for fraud prevention.

In another embodiment, a server system is disclosed. The server system includes a communication interface and a memory including executable instructions. The server system also includes a processor communicably coupled to the memory. The processor is configured to execute the instructions to cause the server system, at least in part, to access a card candidate set from a database associated with the server system. The card candidate set includes one or more relevant payment cards of a plurality of payment cards. Each payment card of the one or more relevant payment cards is associated with a plurality of features. The server system is caused to segregate the plurality of features into a set of risk-related features and a set of transactional features. The server system is further caused to generate, by a set of Machine Learning (ML) models associated with the server system, a riskiness score corresponding to each payment card of the card candidate set based, at least in part, on the set of risk-related features. Further, the server system is caused to perform for each payment card to: assign a particular risk category of one or more risk categories based, at least in part, on the riskiness score and risk categorization criteria; and assign a particular transactional category of one or more transactional categories based, at least in part, on the set of transactional features and transaction behavior criteria. Thereafter, the server system is caused to generate a recommendation message for an issuer based, at least in part, on the risk category and the transactional category assigned to each payment card. The recommendation message is indicative of a remedial action that the issuer needs to perform for fraud prevention.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a card candidate set from a database associated with the server system. The card candidate set may include one or more relevant payment cards of a plurality of payment cards. Each payment card of the one or more relevant payment cards is associated with a plurality of features, The method further includes segregating the plurality of features into a set of risk-related features and a set of transactional features. Further, the method includes generating, by a set of Machine Learning (ML) models associated with the server system, a riskiness score corresponding to each payment card of the card candidate set based, at least in part, on the set of risk-related features. Thereafter, the method includes performing for each payment card: assigning a particular risk category of one or more risk categories based, at least in part, on the riskiness score and risk categorization criteria; and assigning a particular transactional category of one or more transactional categories based, at least in part, on the set of transactional features and transaction behavior criteria. The method includes generating a recommendation message for an issuer based, at least in part, on the risk category and the transactional category assigned to each payment card. The recommendation message is indicative of a remedial action that the issuer needs to perform for fraud prevention.

### BRIEF DESCRIPTION OF THE FIGURES

For a more complete understanding of example embodiments of the present technology, reference is now made to the following descriptions taken in connection with the accompanying drawings, in which:

FIG. 1 illustrates an example representation of an environment related to at least some example embodiments of the present disclosure;

FIG. 2 illustrates a simplified block diagram of a server system, in accordance with an embodiment of the present disclosure;

FIG. 3 illustrates a block diagram of an overall process flow of categorizing one or more payment cards, in accordance with an embodiment of the present disclosure;

FIG. 4 illustrates a block diagram of a process flow of performing a riskiness measure operation on each payment card of a card candidate set, in accordance with an embodiment of the present disclosure;

FIG. 5 illustrates a schematic representation of a risk-based categorization operation, in accordance with an embodiment of the present disclosure;

FIG. 6 illustrates a schematic representation of a transactional behavior-based categorization operation, in accordance with an embodiment of the present disclosure;

FIG. 7 illustrates a flow diagram depicting a method for categorizing the one or more payment cards for fraud prevention, in accordance with an embodiment of the present disclosure; and

FIG. 8 illustrates a simplified block diagram of a payment server, in accordance with an embodiment of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the terms “cardholder”, “user”, “account holder”, “consumer”, and “buyer” are used interchangeably throughout the description and refer to a person who has a payment account or at least one payment card (e.g., credit card, debit card, etc.). The payment card may or may not be associated with the payment account, and will be used by a merchant to complete the payment transaction initiated by the cardholder. The payment account may be opened via an issuing bank or an issuer server.

The term “merchant”, used throughout the description, generally refers to a seller, a retailer, a purchase location, an organization, or any other entity that is in the business of selling goods or providing services. Moreover, it can refer to either a single business location or a chain of business locations of the same entity.

The term “payment account” used throughout the description refers to a financial account that is used to fund a financial transaction. Examples of the financial account include, but are not limited to, a savings account, a credit account, a checking account, and a virtual payment account.

The terms “payment transaction”, “financial transaction”, “e-commerce transactions”, “digital transaction”, and “transaction” are used interchangeably throughout the description and refer to a transaction of a payment of a certain amount being initiated by the cardholder.

The term “issuer”, used throughout the description, refers to a financial institution normally called an “issuer bank” or “issuing bank” in which an individual or an institution may have an account. The issuer also issues a payment card, such as a credit card, a debit card, etc. Further, the issuer may also facilitate online banking services, such as electronic money transfer, bill payment, etc., to the cardholders through a server, which is called “issuer server” throughout the description.

Further, the term “acquirer”, is a financial institution (e.g., a bank) that processes financial transactions for merchants. In other words, this can be an institution that facilitates the processing of payment transactions for physical stores, merchants, or institutions that own platforms that make either online purchases or purchases made via software applications possible (e.g., the shopping cart platform providers and the in-app payment processing providers).

The terms “payment network” and “card network” are used interchangeably throughout the description and refer to a network or collection of systems used for the transfer of funds using cash substitutes. Payment networks may use a variety of different protocols and procedures to process the transfer of money for various types of transactions. Payment networks are companies that connect an issuing bank with an acquiring bank to facilitate online payment. It is to be noted that, the payment networks are operated by organizations that are called “payment processors” throughout the description.

The terms “payment card” and “card” are used interchangeably throughout the description and refer to a physical or virtual card that may or may not be linked with a financial or payment account. It may be presented to a merchant or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards.

### Overview

Various embodiments of the present disclosure provide methods, systems, electronic devices, and computer program products for categorizing payment cards for fraud prevention. In an embodiment, the present disclosure describes a server system that may be embodied within a payment server associated with a payment network. In one embodiment, the server system may access an input dataset from a database associated with the server system. The input dataset may include historical information corresponding to a plurality of payment transactions performed between a plurality of cardholders and a plurality of merchants using a plurality of payment cards. The server system may further generate a plurality of features for each payment card of the plurality of payment cards based, at least in part, on the input dataset. Thereafter, the server system may store the plurality of features in the database, which is accessible for further use.

In an embodiment, the server system is configured to access the plurality of features and a set of predetermined risk scores corresponding to each payment card of the plurality of payment cards from the database. Thereafter, the server system may extract a risky card set from the plurality of payment cards based, at least in part, on the plurality of features, the set of predetermined risk scores, and segregation criteria. In an embodiment, the server system is configured to access a set of cardholder behavioral attributes associated with each payment card of the risky card set from the database. Thereafter, the server system may generate the card candidate set based, at least in part, on the risky card set and the set of cardholder behavioral attributes. The card candidate set may be a subset of the risky card set, which may be stored in the database and is accessible for future use.

In a preferred embodiment of the present disclosure, the server system is configured to access the card candidate set from the database. In an embodiment, the card candidate set includes one or more relevant payment cards of the plurality of payment cards. Herein, each payment card of the one or more relevant payment cards is associated with the plurality of features. Further, in another embodiment, the server system is configured to segregate the plurality of features into a set of risk-related features and a set of transactional features.

In yet another embodiment, the server system is configured to generate a riskiness score corresponding to each payment card based, at least in part, on the set of risk-related features. In a non-limiting example, the server system may generate the riskiness score using a set of Machine Learning (ML) models associated with the server system. More specifically, to generate the riskiness score, the server system may be configured to access the plurality of risk-related features for each payment card from the database. Thereafter, the server system may generate a training risk feature set for each payment card based, at least in part, on the plurality of risk-related features. Then, the server system may use the training risk feature set to train the set of ML models. Then, the server system may compute the riskiness score using the set of ML models post-training. For training the set of ML models, the server system may initially access the training risk feature set for each payment card from the database. Thereafter, the server system may initialize each ML model of the set of ML models with one or more model parameters for the corresponding ML model.

Further, the server system may perform a set of operations iteratively until convergence criteria are met. The set of operations may include generating a set of predicted probability scores based, at least in part, on the training risk feature set and the one or more model parameters of the set of corresponding ML models. Each ML model may generate each predicted probability score of the set of probability scores. Each predicted probability score may indicate a likelihood of each payment card being risky. The set of operations may further include computing a set of losses based, at least in part, on the set of corresponding probability scores, true labels for the corresponding set of ML models, and a loss function. Further, the set of operations may include optimizing the one or more model parameters of each ML model of the set of ML models based, at least in part, on back-propagation of the set of losses of the corresponding set of ML models. In response to meeting the convergence criteria, the server system the server system may obtain a set of final predicted probability scores using the set of ML models. The server system may generate the riskiness score using the set of ML models based, at least in part, on normalizing and performing an ensemble measure on the set of final predicted probability scores.

In an embodiment, the server system may assign a particular risk category of one or more risk categories based, at least in part, on the riskiness score and risk categorization criteria. More specifically, the server system may access the riskiness score of each payment card of the card candidate set from the database. Thereafter, the server system may sort the card candidate set in a predefined order of the riskiness score of each payment card of the card candidate set to obtain a sorted card candidate set. Further, the server system may segregate the sorted card candidate set into one or more card groups based at least on the riskiness score of each payment card of the sorted card candidate set and a set of grouping thresholds. Herein, each payment card of each card group of the one or more card groups may be assigned the particular risk category of the one or more risk categories based at least on the risk categorization criteria.

Further, the server system may assign a particular transactional category of one or more transactional categories based, at least in part, on the set of transactional features and transaction behavior criteria. More specifically, the server system may access the set of transactional features for each payment card of the card candidate set from the database. Further, the server system may identify a spending behavior of each payment card of the card candidate set based, at least in part, on the set of transactional features and a set of transactional thresholds. Herein, each payment card of the card candidate set may be assigned the particular transactional category of the one or more transactional categories based at least on the spending behavior of the corresponding payment card and the transaction behavior criteria.

In an embodiment, the server system is further configured to generate a recommendation message for an issuer based, at least in part, on the risk category and the transactional category assigned to each payment card. The recommendation message may be indicative of a remedial action that the issuer needs to perform for fraud prevention. In some embodiments, the server system is configured to generate a reason code based at least on the risk category and the transactional category assigned to each payment card of the card candidate set. The reason code may be indicative of a reason for generating the corresponding recommendation message.

Various embodiments of the present disclosure offer multiple advantages and technical effects. For instance, the methods and the systems proposed in the present disclosure provide a solution to the problem of complexity involved in deciding on preventive measures based on the riskiness associated with payment cards. This problem is solved by the transmission of a notification indicating an actionable recommendation to the issuer. The proposed method is advantageous compared to conventional techniques because the proposed method generates a new risk score indicating a riskiness associated with each payment card using an ensemble of ML models based on existing risk scores. The notification is generated based on this. The categorization of the payment cards for a particular recommendation is performed not only based on the new risk score but also on the spending pattern of the payment cards. Thus, recommendations generated based on such categorization are considered to be highly precise, and there is a high chance that fraud may be prevented when the issuer takes action based on the recommendations.

Moreover, the proposed method utilizes predictive capabilities by behavioral features given to the ensemble of the ML models at various stages, while retaining explainability using reason codes. As a result, the proposed method is a unique and robust approach that can generate PAN-level insights to re-issue a payment card along with explainable reason codes. Also, the usage of the ensemble of the ML models helps to capture distinctive characteristics of frauds, since they do not belong to a single class of defining traits.

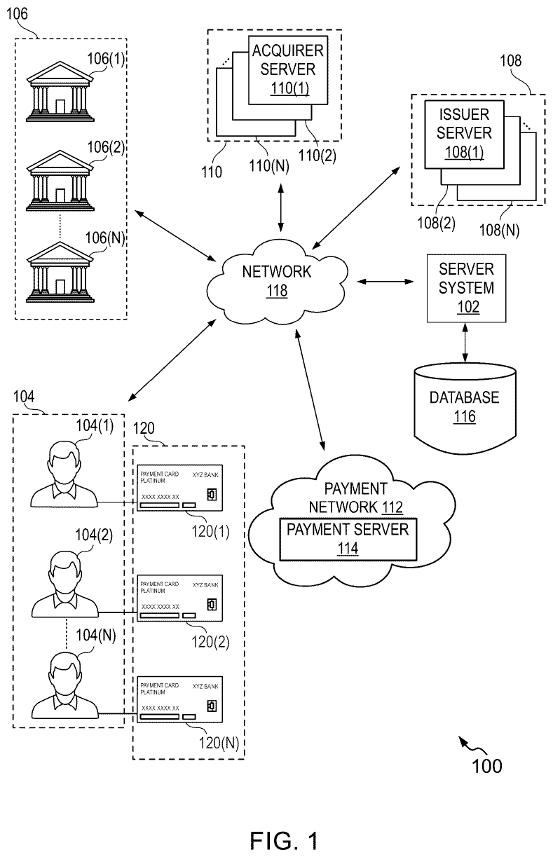

Various example embodiments of the present disclosure are described hereinafter with reference to FIG. 1 to FIG. 8.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise depending on performing one or more operations, for example, assigning a risk category and a transactional category to payment card(s), generating a recommendation message for an issuer based on the categories assigned to the payment card(s), and the like.

The environment 100, generally includes a plurality of entities, such as a server system 102, a plurality of cardholders 104(1), 104(2), . . . 104(N) (collectively referred to hereinafter as a ‘plurality of cardholders 104’ or simply ‘cardholders 104’), a plurality of merchants 106(1), 106(2), . . . 106(N) (collectively referred to hereinafter as a ‘plurality of merchants 106’ or simply ‘merchants 106’), a plurality of issuer servers 108(1), 108(2), . . . 108(N) (collectively referred to hereinafter as a ‘plurality of issuer servers 108’ or simply ‘issuer servers 108’), a plurality of acquirer servers 110(1), 110(2), . . . 110(N) (collectively referred to hereinafter as a ‘plurality of acquirer servers 110’ or simply ‘acquirer servers 110’), a payment network 112 including a payment server 114, and a database 116 each coupled to, and in communication with (and/or with access to) a network 118. Herein, ‘N’ is a non-zero natural number, and the value of ‘N’ may or may not be the same for the plurality of entities shown in FIG. 1.

In an embodiment, the server system 102 may be used by a managing entity (not shown) to train one or more Machine Learning (ML) models for categorizing payment cards associated with cardholders 104 to prevent fraud. As may be understood, the proposed approach is explained with reference to fraud detection in a financial industry. However, it is noted that the proposed approach is also applicable to various other application domains. Examples of the application domains where the proposed approach can be applicable can include categorization of risky entities for anomaly detection and prevention, categorization of patients for disease diagnosis and prevention, outlier detection, weather forecasting, speech recognition, image classification, email spam detection, risk management, charge-back decision-making systems, payment authorization systems, data analytics, credit card scoring systems, cross-border transaction management systems, consumer segmenting, etc., among other application domains without limiting the scope of the proposed approach.

In a non-limiting implementation, the managing entity may be any individual, representative of a person, an institution, an organization, a corporate entity, a non-profit organization, a financial institution (e.g., issuers, acquirers, etc.), a bank, medical facilities (e.g., hospitals, laboratories, etc.), educational institutions, government agencies, telecom industries, or the like. In an example, the managing entity may be an administrator of the server system 102.

In an embodiment, the server system 102 is configured to facilitate the payment processors that control the payment network 112 to perform the above-mentioned operations. In another embodiment, the server system 102 is configured to facilitate issuers to perform the above-mentioned operations. The details of these operations and various other configurations of the server system 102 are explained later in the present disclosure.

In an embodiment, the cardholder (e.g., the cardholder 104(1)) can be any individual, representative of a corporate entity, a non-profit organization, or any other person who is presenting payment account details during an electronic payment transaction. The cardholder (e.g., the cardholder 104(1)) may have a payment account issued by an issuing bank (not shown in figures) associated with an issuer server (e.g., the issuer server 108(1)).

In a non-limiting implementation, the cardholders 104(1)-104(N) may be provided with one or more payment cards 120(1), 120(2), . . . 120(N) (collectively, referred to hereinafter payment cards 120 and where, ‘N’ is a Natural number) respectively, to make the payment transactions with financial or other account information encoded onto the payment cards 120. The information may be encoded in the payment cards 120 such that the cardholders 104 can use the payment cards 120 to initiate and complete payment transactions using a bank account at the issuing bank.

In another non-limiting implementation, the cardholders 104 may use their corresponding electronic devices (not shown in figures) to access a mobile application or a website associated with the issuing bank, or any third-party payment application to perform a payment transaction. In various non-limiting examples, the electronic devices may refer to any electronic devices, such as but not limited to, Personal Computers (PCs), tablet devices, smart wearable devices, Personal Digital Assistants (PDAs), voice-activated assistants, Virtual Reality (VR) devices, smartphones, laptops, and the like.

In an embodiment, the cardholders 104 can be associated with the financial institutions, such as issuing banks that are associated with the issuer servers 108. The terms “issuer bank”, “issuing bank”, or simply “issuer”, “issuer server”, and “issuer servers”, hereinafter may be used interchangeably. It may be understood that a cardholder (e.g., the cardholder 104(1)) may have the payment account with the issuing bank (that may issue a payment card 120(1), such as a credit card or a debit card to the cardholder 104(1)). Further, the issuing banks provide microfinance banking services (e.g., payment transactions using credit/debit cards) for processing electronic payment transactions to the cardholder (e.g., the cardholder 104(1)).

In an embodiment, the merchants 106 can include retail shops, restaurants, supermarkets, or establishments, government and/or private agencies, or any such places equipped with POS terminals, where the cardholders 104 visit to perform financial transactions in exchange for any goods and/or services or any financial transactions. In an embodiment, the merchants 106 are generally associated with financial institutions, such as acquiring banks that are associated with the acquirer servers 110. The terms “acquirer”, “acquirer bank”, “acquiring bank”, “acquirer server”, and “acquirer servers” will be used interchangeably hereinafter. The acquiring bank can be an institution that facilitates the processing of payment transactions for physical stores, merchants, or institutions that own platforms that make either online purchases or purchases made via software applications possible.

In one scenario, the cardholders 104 may use their corresponding payment accounts to conduct payment transactions with the merchants 106. Moreover, it may be noted that each of the cardholders 104 may use their corresponding payment cards 120 differently or make the payment transaction using different means of payment, such as net banking, Unified Payments Interface (UPI) payment, card transaction, cheque transaction, etc. For instance, the cardholder 104(1) may enter payment account details on an electronic device (not shown) associated with the cardholder 104(1) to perform an online payment transaction. In another instance, the cardholder 104(2) may utilize the payment card 120(1) to perform an offline payment transaction. In yet another instance, the cardholder 104(3) may enter details of the payment card 120(1) to transfer funds in the form of fiat currency on an e-commerce platform to buy goods.

Due to the complexity of the banking network, in some embodiments, the cardholder 104(1) and the merchant 106(1) can be associated with the same banking institution, e.g., ABC Bank. In such a situation, the ABC Bank will act as an issuer for the cardholder 104(1) and an acquirer for the merchant 106(1). Thus, a banking institution may act as both an acquirer and/or an issuer, depending on the needs of its clients.

In an embodiment, the payment network 112 may be used by the payment card issuing authorities, such as the issuers, as a payment interchange network. A payment interchange network allows for the exchange of electronic payment transaction data between the issuers and the acquirers. The payment network 112 includes the payment server 114, which is responsible for facilitating the various operations of the payment network 112. In one scenario, the payment server 114 is configured to operate as a payment gateway for facilitating the various entities in the payment network 112 to perform digital transactions.

In various embodiments, the network 118 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 118 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 118 may utilize a secure protocol (e.g., Hypertext Transfer Protocol (HTTP), Secure Socket Lock (SSL), and/or any other protocol, or set of protocols for communicating with the various entities depicted in FIG. 1.

As may be understood, fraud of any type is a threat to any organization or any individual in multiple ways. However, most of the frauds in the financial industry cause more financial losses to service providers such as the merchants 106, and financial institutions such as the issuers and the acquirers over the individuals such as the cardholders 104. In some scenarios, recently, card-related frauds have become one of the major causes of financial losses to the merchants 106 and the financial institutions. Herein, the term ‘card-related fraud’ refers to the fraudulent use of someone else's payment card without their knowledge. The card-related frauds can be either related to any type of the payment cards 120 (e.g., debit cards, credit cards, etc.,). Examples of the card-related frauds include Card-Not-Present (CNP) fraud, credit card skimming, identity theft, Account Takeover (ATO) fraud, phishing, card cracking fraud, and the like.

Conventionally, one or more Artificial Intelligence (AI) or Machine Learning (ML) models (otherwise also referred to as ‘models’ or a ‘model’) are trained to understand behavioral patterns of the cardholders such as the cardholders 104, and identify any unusual transactional activities. Different conventional approaches may generate different types of scores based on the learnings of the models. Such scores can be referred to as ‘risk scores’. Examples of the risk scores include chargeback score, re-issuance score, high-risk score, and the like.

In some scenarios, these scores may be utilized by the merchants 106 and/or the financial institutions as a parameter to decide whether to allow or block a particular transaction request from a particular cardholder (e.g., the cardholder 104(1)) via a particular payment card (e.g., the payment card 120(1)). It may be understood that these scores can be indicative of the likelihood of a particular payment card being risky for permitting the completion of a payment transaction using the said payment card. In some other scenarios, such scores may be utilized by the merchants 106 and/or the financial institutions to identify fraudulent cards and take remedial actions to protect themselves from future fraud. Examples of the remedial actions can be blocking the payment cards, reissuing the payment cards, blocking a particular transaction, notifying the cardholders 104 of the payment cards 120 about an unusual activity, implementing data security controls, and the like.

However, in some scenarios, these scores may not be sufficient to prevent the occurrence of fraud, as the frauds are just detected, and no measures are taken by the conventional techniques to stop the future occurrence of such similar frauds. The remedial actions are decisions that are manually thought out and executed by the affected party, such as the merchants 106 and/or the financial institutions, which is an exhaustive and time-consuming process for the affected party. More specifically, for a model to understand whether a particular payment card (e.g., the payment card 120(1)) is fraudulent or not, it has to identify a pattern that resembles a predefined fraudulent pattern in the historical transaction behavior of the corresponding payment card 120(1). Thus, the payment card 120(1) may have already caused at least a small amount of loss that the affected party may have to face. The risk scores are helpful only to identify fraudulent behavior of the payment cards 120 for the affected parties to take the remedial actions. However, analyzing and understanding the actions or measures that are best suited to prevent the repetition of such fraudulent behavior is a complex task.

In some other scenarios, the risk scores may not be accurate. For instance, a payment card (e.g., the payment card 120(1)) may be detected to be fraudulent based on the risk scores. However, the transactional behavior of a cardholder (e.g., the cardholder 104(1)) of the corresponding payment card 120(1) is observed to be inactive. Thus, a question may arise, ‘how is an inactive user categorized to be fraudulent?’, increasing the chances of the risk scores being less accurate. Thus, mere detection of the fraud is not sufficient. In addition to analyzing the fraudulent behavior of the payment cards 120, analyzing spending behavior associated with the payment cards 120, and generating recommendations of actionable intelligence is also required to prevent the future occurrence of such frauds, and it has to be highly accurate. Therefore, there is a need for a technical solution for providing accurate risk scores and actionable intelligence to the merchants 106 and/or the financial institutions for them to actively take highly accurate remedial actions for fraud prevention.

The above-mentioned technical problems, among other problems, are addressed by one or more embodiments implemented by the server system 102 and the methods thereof provided in the present disclosure. It should be noted that the objective of the server system 102 is to understand the transactional behavior associated with the payment cards 120, in addition to understanding their risky nature. In an embodiment, another objective of the server system 102 is to suggest one or more of the best remedial actions that need to be taken by the merchants 106 and/or the financial institutions to end the continuation of the fraudulent behavior or prevent future fraudulent behavior.

In a specific embodiment, the server system 102 may be used by the payment processors by embedding the server system 102 in the payment server 114. Further, since the merchants 106 and/or the financial institutions, such as the issuers and/or the acquirers, face major losses due to the above-mentioned frauds, the payment processors may provide their services to them. For instance, the issuers may subscribe to the payment processors by providing their credentials. Later, the issuers may transmit a service request to the payment processors through the issuer servers 108. In response to the request, the server system 102 performs various operations to generate a relevant response in the form of a notification. The server system 102 may transmit this notification to the issuers, in response to which the issuers may take any remedial actions to prevent further fraud from being associated with any of the payment cards 120.

In another specific embodiment, the server system 102 may be used by the issuers directly by embedding the server system 102 within the issuer servers 108 associated with the corresponding issuers. In such an embodiment as well, the issuers may initiate a service request to the server system 102 through the issuer servers 108. Upon receiving the service request, the server system 102 may perform the various operations and provide the relevant results to the issuers for them to take the remedial actions.

In a non-limiting implementation, the server system 102 is configured to train one or more AI or ML models using historical data related to the cardholders 104, the merchants 106, or a combination thereof. These models may be trained to perform a classification task, the results of which can be used to achieve one or more objectives of the server system 102. In order to train the ML models, data related to the cardholders 104, the merchants 106, or a combination thereof may have to be accessed. The said data may be referred to as an ‘input dataset’ throughout the description of the present disclosure. It is to be noted that the input dataset may also be needed to perform the various operations on top of it and obtain relevant results. In an embodiment, the database 116 is configured to store the input dataset.

In various non-limiting examples, the database 116 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 116. In one implementation, the database 116 may be viewed, accessed, amended, updated, and/or deleted by an operator or administrator (not shown) associated with the server system 102 through a database management system (DBMS) or relational database management system (RDBMS) present within the database 116.

Further, it may be noted that, in a specific example, the server system 102 coupled with the database 116 is embodied within an issuer server (e.g., the issuer server 108(1)), however, in other examples, the server system 102 can be a standalone component (acting as a hub) connected to the payment server 114 and the acquirer servers 110. The database 116 may be incorporated in the server system 102, or maybe an individual entity connected to the server system 102, or maybe a database stored in cloud storage.

In an embodiment, the input dataset may include historical information corresponding to a plurality of payment transactions performed between the cardholders 104 and the merchants 106. In a specific embodiment, the payment transactions are performed using the payment cards 120. In an embodiment, the historical information may include, but is not limited to, transaction attributes, such as transaction amount, source of funds, such as bank accounts, debit cards or credit cards, transaction channel used for loading funds, such as POS terminal or Automated Teller Machine (ATM), transaction velocity features, such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, etc., among other transaction-related attributes.

In other various examples, the database 116 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data. In addition, the database 116 provides a storage location for data and/or metadata obtained from various operations performed by the server system 102.

Further, in some example implementations, the input dataset can also include transactional information, such as, but not limited to, account compromise information, merchant fraud monitoring information, high-risk channels information, chargeback risk information, card behavioral pattern information, and the like. In some other implementations, the database 116 may also store a set of predetermined risk scores (otherwise also referred to as ‘scores’ throughout the description) that may be accessed from various data sources. In an embodiment, the data sources can be internal to the payment processors and/or the issuers. In another embodiment, the data sources can be external to the payment processors and/or the issuers. In some embodiments, the data sources can correspond to various products that are part of conventional systems that can provide predictions, scores, etc., related to risk, spending patterns, fraud, etc. In some embodiments, the set of predetermined risk scores may be generated based on the input dataset. Examples of the predetermined risk scores may include the re-issuance score, the high-risk channel, the chargeback risk score, the decision-making score, and the like. It is to be noted that, in some embodiments, these scores may have been determined or generated by the conventional systems, using the ML models. Examples of the ML models can include classifiers, an extreme gradient boosting (XGBoost) model, ensemble models, Neural Networks (NNs), anomaly score learners, etc. In some other embodiments, these scores may have been generated by the conventional systems using a rule-based approach. It may be noted that all this information that is stored in the database 116 may be accessible to the server system 102 as a part of the input dataset.

As used herein, the term ‘re-issuance score’ refers to a score that indicates a propensity of reissuing a payment card to a cardholder based on the fraudulent behavior of the cardholder. For instance, the score can be between 0 to 1000, indicating whether a card should be reissued. If it has a high score value, then it indicates a higher chance of fraud occurring on the payment card in an upcoming predefined time interval, for example, the next 3 months. It is noted that the range 0 to 1000 is just an example, and this range can be changed based on the specific implementation without departing from the scope of the present disclosure. Similarly, the term ‘chargeback risk score’ captures the probability of the payment card, analogously doing a chargeback. Further, the term ‘high-risk score’ indicates the likelihood of the card information having been compromised or the payment card having interacted with a risky merchant. Furthermore, the term ‘decision-making score’ is another risk score that indicates the likelihood of the occurrence of fraud in real-time during a transaction authorization. For instance, if the decision-making score is associated with each transaction and is aggregated over a period of the last 1 month or 3 months of transactions for each payment card. It is to be noted that the maximum decision-making score for payment transactions in that time period is taken as the corresponding decision-making score for the payment card. In some embodiments, the scores can also include an additional score such as a behavioral score. The term ‘behavioral score’ refers to another risk score that encodes the deviation of a payment card from its typical behavioral patterns so that the anomalous behavior is calibrated according to each cardholder's spending characteristics.

Further, in an embodiment, the server system 102 is configured to access the input dataset from the database 116 for generating a plurality of features. In an embodiment, the features may be generated for at least one payment card (e.g., the payment card 120(1)) of the payment cards 120. In another embodiment, the server system 102 may generate the plurality of features (referred herein interchangeably simply as ‘features’) for each payment card. Further, these features may be stored back to the database 116 and are accessible for future processing. It is to be noted that the generation of the features from the input dataset may provide additional insights into the behavior and usage of each of the payment cards 120.

Furthermore, in an embodiment, the server system 102 is configured to access the features, the set of predetermined risk scores, and a set of cardholder behavioral attributes from the database 116. The term ‘cardholder behavioral attributes’ refers to attributes related to a cardholder that describe the spending behavior of the cardholder. The server system 102 is further configured to generate a card candidate set from the payment cards 120 based, at least in part, on the features, the set of predetermined risk scores, segregation criteria, and the set of cardholder behavioral attributes. Herein, the card candidate set may include one or more relevant payment cards of the payment cards 120. As one of the objectives disclosed in the present disclosure is to identify fraudulent payment cards, the relevance of the segregation of the payment cards into the card candidate set indicates that the card candidate set may include a set of risky payment cards. Thus, it may be understood that the segregation criteria may relate to an extent of risk that may be associated with the payment cards 120. Herein, the term ‘risk’ refers to the cumulative exposure arising from potential fraud, chargebacks, or any other undesirable events. Also, in a non-limiting implementation, the segregation criteria may also describe different thresholds for different scores, indicating the extent of risk based on which the card candidate set may be prepared. Upon generating the card candidate set, it may be stored in the database 116.

In another embodiment, the server system 102 is configured to access the card candidate set from the database 116. Each payment card in the card candidate set may be associated with the features. The server system 102 may further segregate these features that are associated with each payment card of the card candidate set into a set of risk-related features and a set of transactional features.

In yet another embodiment, the server system 102 assigns to each payment card from the card candidate set, a particular risk category of one or more risk categories based, at least in part, on the set of risk-related features and risk categorization criteria. In another embodiment, in addition to assigning the risk category, the server system 102 assigns a particular transactional category of one or more transactional categories based, at least in part, on the set of transactional features and transaction behavior criteria.

Further, in an embodiment, the server system 102 generates a recommendation message for an issuer based, at least in part, on the risk category and the transactional category assigned to each payment card. The recommendation message is indicative of a remedial action that the issuer needs to perform for fraud prevention. In some embodiments, the recommendation message is communicated to the issuer server 108(1) associated with the issuer to inform the issuer about the remedial action. It is noted that the process of generating the card candidate set, assigning the risk category and the transactional category to each payment card in the card candidate set, and generating the recommendation for the issuer based on the categorization is explained in detail later in the present disclosure.

As may be appreciated, the recommendations generated based on such categorization are considered to be highly precise, and there is a high chance that fraud may be prevented when the issuer takes action based on the recommendations. Also, the usage of the ensemble of the ML models (i.e., the set of ML models) helps to capture distinctive characteristics of frauds, since they do not belong to a single class of defining traits.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 118, which may be specifically configured, via executable instructions, to perform steps as described herein, and/or embodied in at least one non-transitory computer-readable media. More specifically, it should be noted that the number of the cardholders 104, the merchants 106, the issuer servers 108, the acquirer servers 110, the payment network 112, and the database 116 described herein are only used for exemplary purposes and do not limit the scope of the invention.

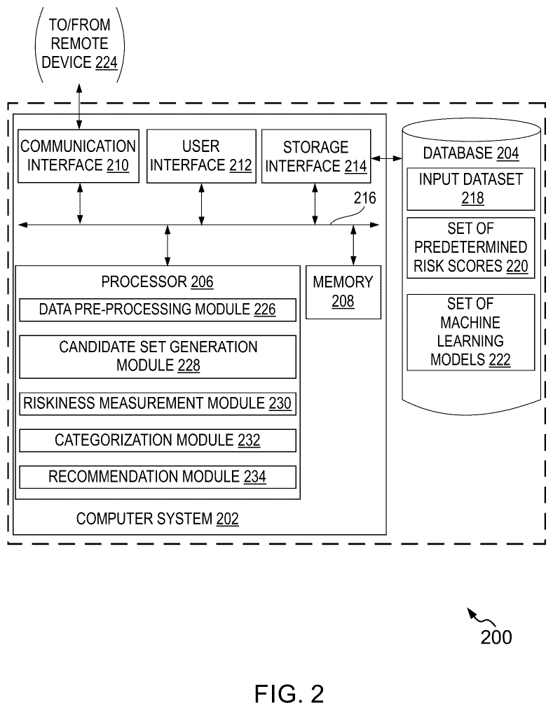

FIG. 2 illustrates a simplified block diagram of a server system 200, in accordance with an embodiment of the present disclosure. For example, the server system 200 is similar to the server system 102 as described in FIG. 1. In some embodiments, the server system 200 is embodied as a standalone physical server and/or has a cloud-based and/or SaaS-based (software as a service) architecture.

The server system 200 includes a computer system 202 and a database 204. The computer system 202 includes at least one processor such as a processor 206, for executing instructions, a memory 208, a communication interface 210, a user interface 212, and a storage interface 214. The one or more components of the computer system 202 communicate with each other via a bus 216. The components of the server system 200 provided herein may not be exhaustive, and the server system 200 may include more or fewer components than those depicted in FIG. 2. Further, two or more components depicted in FIG. 2 may be embodied in one single component, and/or one component may be configured using multiple sub-components to achieve the desired functionalities. The database 204 is an example of the database 116 of FIG. 1.

In some embodiments, the database 204 is integrated into the computer system 202. For example, the computer system 202 may include one or more hard disk drives as the database 204. In one non-limiting example, the database 204 is configured to store an input dataset 218, a set of predetermined risk scores 220, a set of Machine Learning (ML) models 222, and the like. Herein, the input dataset 218 and the ML models 222 are similar to the input dataset and the ML models described in FIG. 1.

Further, the computer system 202 may include one or more hard disk drives as the database 204. The user interface 212 is an interface, such as a Human Machine Interface (HMI) or a software application, that allows users such as an administrator, to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for categorizing the payment cards 120 for fraud prevention. Examples of the processor 206 include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), and the like.

In an embodiment, the memory 208 is capable of storing the computer-readable instructions. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 224, such as the issuer servers 108, the acquirer servers 110, or with any entity connected to the network 118 (as shown in FIG. 1).

It is to be noted that the server system 200 as illustrated and hereinafter described, is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include a data pre-processing module 226, a candidate set generation module 228, a riskiness measurement module 230, a categorization module 232, and a recommendation module 234. It should be noted that components, described herein, can be configured in a variety of ways, including electronic circuitries, digital arithmetic, logic blocks, and memory systems in combination with software, firmware, and embedded technologies. Moreover, it should also be noted that these components may be communicably coupled with each other to exchange information with each other for performing the one or more operations facilitated by the server system 200.

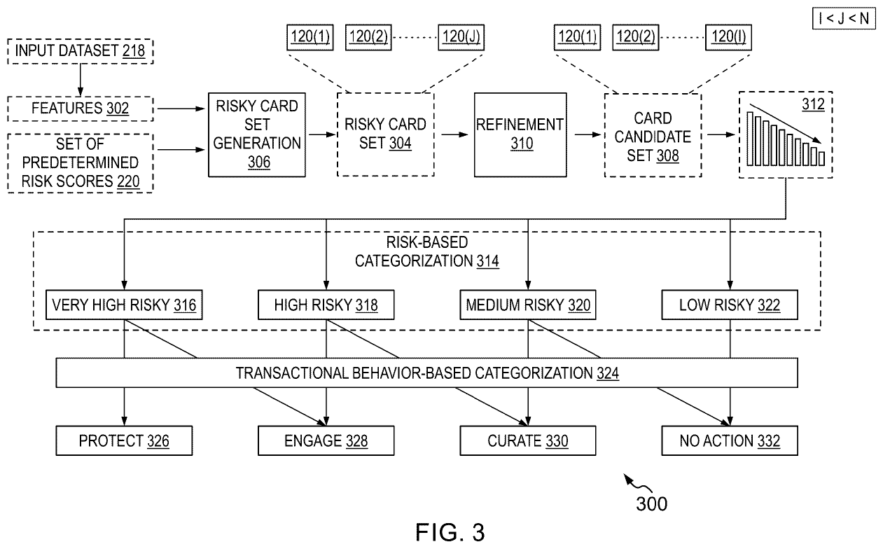

In an embodiment, the data pre-processing module 226 includes suitable logic and/or interfaces for accessing the input dataset 218 from the database 204. Further, the data pre-processing module 226 may be configured to generate the plurality of features (e.g., the features 302 as shown in FIG. 3) based, at least in part, on the input dataset 218. In an embodiment, the features are generated using one or more feature extraction or generation techniques. In various non-limiting examples, the feature extraction or generation techniques may include one-hot encoding, domain-specific feature engineering, target encoding, binning, logarithmic transformation, and the like. As may be understood, the features 302 may be generated for each payment card 120. The data pre-processing module 226 may further store the features 302 in the database 204.

In a non-limiting implementation, the features 302 may include a large number of features indicating behavioral properties or patterns associated with the payment cards 120. For example, the features 302 may include a count/volume of the recent payment transaction and typical transactions, a count/volume of cross-border and domestic transactions, a count/volume of card-present (CP) and CNP transactions, an interaction with top ‘k’ risky merchants (Herein, ‘k’ is a non-zero natural number), their fraud risk rates and other merchant level features, issuer level features such as fraud probability within issuing cards, product bins, and the like. In an embodiment, these features 302, along with the input dataset 218 are provided to the candidate set generation module 228 for further processing as shown in FIG. 3.

In an embodiment, the candidate set generation module 228 includes suitable logic and/or interfaces for accessing the features and the set of predetermined risk scores 220 corresponding to each payment card of the payment cards 120 from the database 204. The candidate set generation module 228 may be configured to extract a risky card set (e.g., a risky card set 304, as shown in FIG. 3) from the payment cards 120 based, at least in part, on the features 302, the set of predetermined risk scores 220, and the segregation criteria. The risky card set 304 may include one or more risky cards (e.g., the payment cards 120(1)-120(j) (as shown in FIG. 3), ‘j’ being a non-zero natural number less than ‘N’) of the payment cards 120(1)-120(N) shown in FIG. 1 that may be assumed as risky for the sake of this example. Herein, in a specific instance, the extent of risk associated with the risky card set 304 is dependent on the segregation criteria. In a non-limiting implementation, the segregation criteria may indicate selecting payment cards based on the set of predetermined risk scores 220 and a set of thresholds to obtain the risky card set 304. In a non-limiting instance, the set of thresholds may be predefined by individuals such as an administrator of the server system 200. More specifically, the risky card set 304 may have the payment cards that have the re-issuance score of at least equal to a value ‘x’, the high-risk score of at least equal to a value ‘y’, the chargeback score of at least equal to a value ‘z’, and the decision-making score at least equal to a value ‘w’, and the like. Herein, the values x, y, z, and w may correspond to non-zero natural numbers. In some embodiments, these values can be set to the same number. In some other embodiments, these values can be set differently from each other. For example, a typical threshold for the scores (e.g., the set of predetermined risk scores 220) can be between a range of about 800 to about 990. It is noted that this range is just a non-limiting example and can be changed as per the implementation. It is to be noted that the set of thresholds can be tightened or relaxed based on the number of payment cards required in the risky card set 304. Alternatively, the set of thresholds can be changed based on the payment cards that need to be alerted to the issuer. In either of the cases, the set of thresholds can be predetermined according to the objectives of the issuer. In some other instances, additional thresholds using other attributes can be added depending on the requirements of the issuer.

It is to be noted that the above-described process of generating the risky card set 304 can be referred to as a step of ‘risky card set generation’ (see, 306) as shown in FIG. 3. In another embodiment, the candidate set generation module 228 is configured to refine the risky card set 304 to generate a refined card candidate set such as a card candidate set 308 as shown in FIG. 3. Herein, the card candidate set 308 may include one or more relevant cards (e.g., the payment cards 120(1)-120(i) (as shown in FIG. 3), ‘i’ being a non-zero natural number less than ‘j’) of the payment cards 120(1)-120(j) of FIG. 1 that may be assumed as relevant for the sake of this example.

In a specific embodiment, for refining the risky card set 304, the candidate set generation module 228 is configured to access a set of cardholder behavioral attributes from the database 204. For instance, the set of cardholder behavioral attributes includes card activity in the last x days (ranging from about 15 days to about 2 months), an increase in decline rates (indicating the number of decline transactions to total transactions) in the last x days, and so on. The candidate set generation module 228 may generate the card candidate set 308 based, at least in part, on the risky card set 304 and the set of cardholder behavioral attributes. Herein, the process of refining the risky card set 304 can be referred to as a step of ‘refinement’ (see, 310) as shown in FIG. 3. Once the card candidate set 308 is obtained, the candidate set generation module 228 may store the final set, i.e., the card candidate set 308 to the database 204 which is accessible for future use. In an embodiment, the card candidate set 308 is provided to the riskiness measurement module 230 for further processing.

As may be understood, the set of predetermined risk scores 220 considered for obtaining the card candidate set 308 is derived from the conventional techniques. Also, it is to be noted that these scores are less accurate. Thus, the card candidate set 308, having the one or more relevant payment cards of the payment cards 120 cannot be considered as a precisely classified or categorized list of relevant payment cards. These payment cards require further segmentation into different groups, each group having a different riskiness level, so that groups with different riskiness levels are treated differently and appropriately as per their riskiness level.

Thus, in an embodiment, the riskiness measurement module 230 includes suitable logic and/or interfaces for accessing the card candidate set 308 from the database 204. The riskiness measurement module 230 may perform a riskiness measure operation (see, 312) on the card candidate set 308 as shown in FIG. 3. The process of the riskiness measure operation 312 is explained later in the present disclosure. Upon performing the riskiness measure operation 312, the card candidate set 308 is categorized further into one or more categories, as explained with reference to FIG. 3.

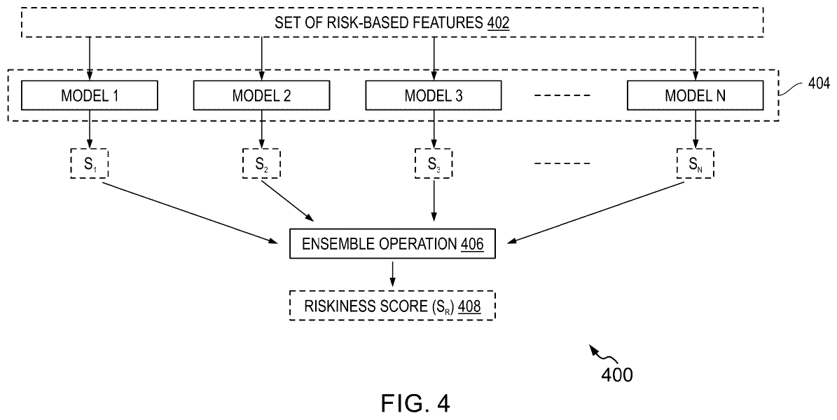

Referring to FIG. 3, which illustrates a block diagram of an overall process flow 300 of categorizing one or more payment cards (e.g., the payment cards 120), in accordance with an embodiment of the present disclosure. As may be understood, initially, the card candidate set 308 is obtained from the payment cards 120. Then, the card candidate set 308 is further categorized into different categories. It is to be noted that the results of the riskiness measure operation 312 (explained later in the present disclosure with reference to FIG. 4) that is performed on the card candidate set 308 include analyzing a riskiness score set, with an individual riskiness score being assigned to each payment card of the card candidate set 308. In an embodiment, a ‘risk-based categorization’ 314 operation is performed on each payment card of the card candidate set 308, resulting in assigning a particular risk category of one or more risk categories to each payment card. Examples of the one or more risk categories include ‘very high risky’ 316, ‘high risky’ 318, ‘medium risky’ 320, and ‘low risky’ 322. In an embodiment, the ‘risk-based categorization’ 314 operation is performed by the categorization module 232. Thus, the categorization module 232 may include suitable logic and/or interfaces assigning the particular risk category of the one or more risk categories (e.g., the ‘very high risky’ 316, the ‘high risky’ 318, the ‘medium risky’ 320, and the ‘low risky’ 322) to each payment card of the card candidate set 308 based, at least in part, on the riskiness score and risk categorization criteria. It is noted that these risk category terms are only exemplary in nature, and any other terms may be used as well.

More specifically, the categorization module 232 may access the riskiness score of each payment card of the card candidate set 308 from the database 204. The categorization module 232 may sort the card candidate set 308 in a predefined order of the riskiness score of each payment card of the card candidate set 308 to obtain a sorted card candidate set (not shown in FIG. 3). In various embodiments, the predefined order can be an ascending order, a descending order, or any other order without limiting the scope of the present disclosure. Further, the categorization module 232 may segregate the sorted card candidate set into one or more card groups based, at least in part, on the riskiness score of each payment card of the sorted card candidate set and a set of grouping thresholds. Herein, each payment card of each card group of the one or more card groups is assigned the particular risk category of the one or more risk categories based at least on the risk categorization criteria.

In some embodiments, the risk categorization criteria include considering a first card group of the one or more card groups including the top set of payment cards from the card candidate set 308 as ‘very high risky’ 316, a second card group of the one or more card groups including a another set of payment cards in the card candidate set 308 as ‘high risky’ 318, a third card group of the one or more card groups including a yet another set of payment cards in the card candidate set 308 as ‘medium risky’ 320, and a fourth card group of the one or more card groups including remaining payment cards in the card candidate set 308 as ‘low risky’ 322. Herein, the top set of payment cards corresponding to payment cards in the card candidate set 308 has the riskiness score at least equal to a first threshold. The another set has payment cards that are assigned the riskiness score at least equal to a second threshold and less than the first threshold. Similarly, the yet another set has payment cards that are assigned the riskiness score at least equal to a third threshold and less than the second threshold. Finally, the remaining payment cards are assigned the riskiness score at least equal to a fourth threshold and less than the third threshold. Herein, it is to be noted that the first threshold may be greater than the second threshold. The second threshold is greater than the third threshold, and the third threshold is greater than the fourth threshold. Thus, it may be understood that different percentages of the payment cards may be assigned different risk categories based on the predefined order of the riskiness score and the set of grouping thresholds. The set of grouping thresholds can include the first threshold, the second threshold, the third threshold, and the fourth threshold. In a specific non-limiting implementation, it is to be noted that these grouping thresholds can be set anywhere between 0.8% to 2% of payment cards based on the requirements set by the administrator of the server system 200. In a non-limiting implementation, these groups can be subsequently located. For example, the top 0.8% can be categorized within the risk category of the ‘very high risky’ 316, subsequent 0.4% can be categorized within the risk category of the ‘high risky’ 318, subsequent 0.5% can be categorized within the risk category of ‘medium category’ 320, and the remaining payment cards in the card candidate set 308 can be categorized within the risk category of ‘low risky’ 322.

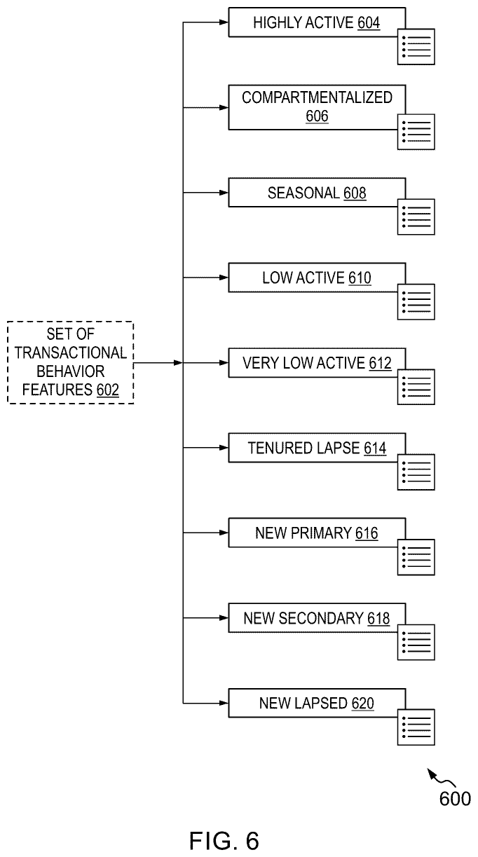

Upon completion of the ‘risk-based categorization’ 314 operation, a ‘transactional behavior-based categorization’ 324 operation may be performed on the card candidate set 308. It may be understood that this operation is performed on the same set of payment cards, i.e., the card candidate set 308 by the categorization module 232. However, the basis of the operation is different from that of the ‘risk-based categorization’ 314 operation. Thus, in another embodiment, the categorization module 232 is configured to assign a particular transactional category of one or more transactional categories based, at least in part, on a set of transactional features (see, 602) as shown in FIG. 6 (see, transactional behavior-based categorization operation 600) and transaction behavior criteria. Herein, the transactional behavior-based categorization operation 600 is similar to the ‘transactional behavior-based categorization’ 324 operation.

In a non-limiting implementation, for performing the ‘transactional behavior-based categorization’ 324 operation, the categorization module 232 may also be configured to access the set of transactional features 602 associated with each payment card of the card candidate set 308 from the database 204. The categorization module 232 may identify a spending behavior of each payment card of the card candidate set 308 based, at least in part, on the set of transactional features 602 and a set of transactional thresholds as shown in FIG. 6. Herein, each payment card of the card candidate set 308 is assigned the particular transactional category of the one or more transactional categories based at least on the spending behavior of the corresponding payment card and the transaction behavior criteria. Examples of the transactional categories include ‘highly active’ 604, ‘compartmentalized’ 606, ‘seasonal’ 608, ‘low active’ 610, ‘very low active’ 612, ‘tenured lapse’ 614, ‘new primary’ 616, ‘new secondary’ 618, and ‘new lapsed’ 620 as shown in FIG. 6. It is noted that these transactional category terms are only exemplary in nature, and any other terms may be used as well.

In a non-limiting implementation, the set of transactional features 602 of each payment card of the card candidate set 308 may include, but is not limited to, the total yearly amount spent by the payment card, the number of different industries the payment card is been transacting to, the number of days the payment card has been active, and the like. In an embodiment, the transaction behavior criteria indicate the spending behavior associated with each payment card in the card candidate set 308 having a specific pattern matching with at least one of the transactional categories 604-620. In a non-limiting implementation, the transactional thresholds are internal and specific to each transactional category. By way of an exemplary scenario, and not by limitation, the definitions of the transactional categories 604-620, which also provide their respective transactional thresholds, are elaborated in the following table:

TABLE 1
Definitions of the transactional categories
for an exemplary scenario

| Sl | Transactional | |
|---|---|---|
| No. | categories | Definitions |
| 1 | Highly Active | Yearly Spend >=$3,000 and spend active in |
| | | recent 7 months and active in >=11 months |
| | | and >=20 industries |
| 2 | Compart- | Yearly Spend >=$3,000 and spend active in |
| | mentalized | recent 7 months and active in >=11 months |
| | | and <20 industries |
| 3 | Seasonal | Yearly Spend >=$3,000 and spend active in |
| | | recent 7 months and active in <=10 months |
| | | and >=20 industries |
| 4 | Low Active | Yearly Spend >=$3,000 and spend active in |
| | | recent 7 months and active in <=10 months |
| | | and <20 industries |
| 5 | Very Low | Yearly Spend <$3,000 and spend active in recent |
| | Active | 7 months |
| 6 | Tenured | No spending in recent 7 months |
| | Lapsed | |
| 7 | New Primary | Spend active in recent 5 months and active |
| | | in >=15 industries |
| 8 | New Secondary | Spend active in recent 5 months and active in <15 |
| | | industries |
| 9 | New Lapsed | No spending in recent 5 months |

It is to be noted that the values in Table 1 are exemplary in nature for an exemplary scenario. To that end, these values should not be construed as a limitation on the scope of the present disclosure.

In some embodiments, the categorization module 232 may perform the ‘transactional behavior-based categorization’ 324 operation using a rule-based approach. In some other embodiments, the ‘transactional behavior-based categorization’ 324 may be performed using a multi-class classification model. In a non-limiting implementation, when the multi-class classification model may be used for performing this operation, the multi-class classification model may be trained based on the set of transactional features 602. Moreover, the training process is similar to training any AI or ML models such as the ML models 222, which is well known to a person skilled in the art and hence is not repeated herein for the sake of brevity.

Further, in an embodiment, upon the categorization of the card candidate set 308 in the risk-based categories and the transactional behavior-based categories 604-620, one or more recommendations may be generated for an issuer corresponding to each payment card of the card candidate set 308. It is noted that the generation of the recommendations for the issuer may technically mean that the recommendations are generated and transmitted to the issuer server 108(1) associated with the issuer.

Referring back to FIG. 2, in a non-limiting implementation, the recommendations may be generated using the recommendation module 234 of FIG. 2. The recommendation module 234 includes suitable logic and/or interfaces for generating a recommendation message for the issuer based, at least in part, on the risk category and the transactional category assigned to each payment card. The recommendation message may be indicative of a remedial action that the issuer needs to perform for fraud prevention.

In another embodiment, the recommendation module 234 may be configured to transmit a notification to the issuer based, at least at least in part, on the risk category and the transactional category assigned to each payment card of the card candidate set 308. In a non-limiting example, the notification may indicate the recommendation message. In other words, the recommendation message may be communicated to the issuer server associated with the issuer to inform the issuer about the remedial action.

Examples of the recommendations may include ‘protect’ 326, ‘engage’ 328, ‘curate’ 330, and ‘no action’ 332 as shown in FIG. 3. For instance, when the recommendation is ‘protect’ 326 for a particular payment card, then it indicates an action of reissuing new payment cards as a priority. Similarly, when the recommendation is ‘enable’ 328, it indicates the action of reissuing new payment cards based on additional analysis such as risk exposure, etc. Further, when the recommendation is ‘curate’ 330, it indicates an action of flagging the corresponding payment card's transaction. Finally, the recommendation ‘no action’ 332 indicates that no action needs to be taken by the issuer. It is noted that these recommendation terms are only exemplary in nature, and any other terms may be used as well.

For example, if a payment card is in the transactional category of ‘highly active’ 604 in recent months with a high spend amount, and it lies in the risk category of ‘very high risky’ 316 (indicating fraud might happen in the near future) as well. Then the recommendation is to re-issue that card immediately, i.e., ‘protect’ 326. But, if the same payment card is in the risk category of ‘high risky’ 318, then the recommendation would be to ‘engage’ 328 for that payment card.

As per another example, if a payment card has been moderately active in recent months with a moderate spend amount, and it lies in the risk category of ‘very high risky’ 316. Then, the recommendation would be to ‘engage’ 328 for that particular payment card. But, if the same payment card is in the risk category of ‘high risky’ 318, then the recommendation would be to ‘curate’ 330.

As per yet another example, if a payment card has not been very active in recent months and has very little spending amount with no risky transactions at all, then the recommendation would be ‘no action’ 332.

In some embodiments, the recommendation module 234 is configured to generate a reason code based at least on the risk category and the transactional category assigned to each payment card of the card candidate set 308. The reason code may be indicative of a reason for generating the corresponding recommendation message. In an embodiment, the recommendation message transmitted to the issuer may be transmitted by associating the recommendation message with the reason code. Herein, the term ‘reason code’ refers to a predefined code that indicates a reason that can be associated with any task. It may be system-generated, and its associated reason may be stored in the database 204 along with the corresponding reason code. It is noted that the reason code can be defined by the administrator (not shown) and distributed to the issuers and acquirers. Reason codes are standard codes, each of which corresponds to a specific reason in a globally available list of reasons. For example, a reason code ‘PF23’ shared by the server system 200 may correspond to ‘A high fraud likelihood in future’ reason in the list available to the issuer. In other words, reason codes help the issuers or acquirers identify the reason for which the said code is shared. Due to the limited capability of messages (generally, XML messages) used to communicate between different entities in the payment network 112, it becomes pertinent to communicate using short-form codes that can be cross-referenced easily by the issuers, acquirers, or payment servers with their locally stored list of reasons. It is noted that generally, this list of reasons is identical for everyone in the payment network 112. This is done to ensure cross-platform compatibility. However, in some instances, dedicated lists may be given to these entities as well. In a specific embodiment, the reason codes are generated based on the input features such as the features 302 that have the most deviation (usually three standard deviations) from the typical behavior in the overall population and from the payment cards' own usage patterns. In a non-limiting implementation, the reason codes that may be generated may correspond to the following reasons:
(i) Risky merchant interaction.
(ii) Suspicious transactions (within subcategories, say cross-border, card-present, etc.).
(iii) High decision-making score (for cards that have one or many transactions in the last two weeks, with a high decision-making score).
(iv) Non-active (the card must have appeared in a segment that received a recommendation of ‘protect’ 326 in the last segment and has shown riskiness indicators recently but has been non-active since. This reason code is only issued under the recommendation of ‘curate’ 330).

As may be appreciated, the recommendations generated based on such categorization are considered to be highly precise, and there is a high chance that fraud may be prevented when the issuer takes action based on the recommendations. Moreover, the proposed method utilizes predictive capabilities by behavioral features given to the ensemble of the ML models at various stages, while retaining explainability using reason codes. As a result, the proposed method is a unique and robust approach that can generate PAN-level insights to re-issue a payment card along with explainable reason codes. Also, the usage of the ensemble of the ML models (i.e., the set of ML models 222) helps to capture distinctive characteristics of frauds, since they do not belong to a single class of defining traits.

FIG. 4 illustrates a block diagram of a process flow 400 of performing a riskiness measure operation (e.g., the riskiness measure operation 312) on each payment card of a card candidate set (e.g., the card candidate set 308), in accordance with an embodiment of the present disclosure. As may be understood, the card candidate set 308 includes the one or more relevant payment cards of the payment cards 120 and is associated with the features. Further, in an embodiment, the riskiness measurement module 230 is configured to segregate the features into a set of risk-related features 402 and the set of transactional features 602 (as shown in FIG. 6).

In a non-limiting instance, for performing the riskiness measure operation 312, the riskiness measurement module 230 may provide the set of risk-related features 402 to a set of ML models 404, such as a model 1, a model 2, model 3, . . . , model N. Herein, ‘N’ is a non-zero natural number. In an embodiment, the set of ML models 404 may be similar to the ML models 222 of FIG. 2. Examples of the set of risk-related features 402 may include encapsulating card characteristics, interaction details, compromise information, fraud riskiness scores, chargeback riskiness scores, and the like, corresponding to the relevant payment cards in the card candidate set 308. Further, examples of the set of ML models 404 may include XGBoost, logistic regression, K-nearest neighbor, decision tree classifier, Support Vector Machine (SVM), Gaussian naive Bayes, and the like. The set of ML models 404 may also include anomaly detection models such as the Local Outlier Factor (LOF), Isolation Forest (IF), Deep Semi-Supervised Anomaly Detection (DeepSAD) model, and the like. Herein, an ensemble of the ML models may be selected to form the set of ML models 404.

In a specific embodiment, the riskiness measurement module 230 is configured to access the plurality of risk-related features 402 for each payment card of the card candidate set 308 from the database 204. Further, the riskiness measurement module 230 may generate a training risk feature set for each payment card based, at least in part, on the plurality of risk-related features 402. In other words, the set of risk-related features 402 may be split into the training risk feature set, a testing risk feature set, and a validation risk feature set by segregating said features based on a timeline. The riskiness measurement module 230 may use the training risk feature set to train the set of ML models 404. Later, the set of ML models 404 may be tested and validated by using the testing risk feature set and the validation risk feature set, respectively. In an embodiment, the riskiness measurement module 230 may perform an Out of Time testing, so that the three different sets (i.e., for training, test, and validation) are obtained from the card candidate set 308 across three periods of time, so that the set of ML models 404 for a more robust optimal model. Later, in an embodiment, the riskiness measurement module 230 is configured to compute the riskiness score 408 using the set of ML models 404.

In an embodiment, for training the set of ML models 404, the riskiness measurement module 230 is configured to access the training risk feature set for each payment card from the database 204. Further, the riskiness measurement module 230 may initialize each ML model (e.g., model 1, model 2, model 3, . . . , model N) of the set of ML models 404 with one or more model parameters for the corresponding ML model.

The riskiness measurement module 230 may further perform a set of operations iteratively, via the set of ML models 404, until convergence criteria are met. The set of operations may include generating a set of predicted probability scores based, at least in part, on the training risk feature set and the one or more model parameters of the set of corresponding ML models (e.g., the set of ML models 404). Each ML model may generate each predicted probability score of the set of probability scores. Further, each predicted probability score may indicate a likelihood of each payment card being risky.

The set of operations may further include computing a set of losses based, at least in part, on the set of corresponding probability scores, true labels for the corresponding set of ML models (e.g., the set of ML models 404), and a loss function. Further, the set of operations may include optimizing the one or more model parameters of each ML model of the set of ML models (e.g., the set of ML models 404) based, at least in part, on back-propagation of the set of losses of the corresponding set of ML models (e.g., the set of ML models 404).

Further, in response to meeting the convergence criteria, the riskiness measurement module 230 may obtain a set of final predicted probability scores using the set of ML models 404. Thereafter, the riskiness measurement module 230 may generate the riskiness score 408 using the set of ML models 404 based, at least in part, on normalizing and performing an ensemble measure on the set of final predicted probability scores.

In an embodiment, the convergence criteria include saturation of a performance parameter such as the Area under the curve Precision-Recall (AUC_PR). In an embodiment, the final predicted probability scores may be taken from the set of ML models 404 at a point when the best validation AUC_PR is achieved. It is the point at which the ensemble of the set of ML models 404 is considered to form an optimal model.

In a specific example, when one of the set of ML models 404 is the DeepSAD model, then a 2-layered Multi-Layer Perceptron (MLP) may be utilized to get embedding vectors from the set of risk-related features 402. The MLP classifier can be trained by bringing features of non-fraudulent payment cards closer to the center of a population encapsulated by a normal vector, while the fraud features are trained to go farther away from the normal using a DeepSAD loss. For other models, typical implementation details may be followed and are well known to a person skilled in the art, and hence not repeated in the present invention.

In a non-limiting implementation, the final predicted probability scores generated by each of the set of ML models 404, such as by the model 1, model 2, . . . model N can be S₁, S₂, . . . S_{N}, respectively. As described earlier, the riskiness measurement module 230 is configured to apply the ensemble measure such as an ensemble operation 406, on the final predicted probability scores based at least on ensemble criteria. Herein, the ensemble criteria may indicate an ensemble technique that may be preferred to perform the ensemble operation 406. In a specific example, a basic ensemble measure is to take the Euclidean distance of each of the scores from zero, which gives an overall riskiness score such as the riskiness score (S_{R}) 408. In other examples, other ways to ensemble the scores include Max/Mean-Pooling, a stacked classifier, and the like. More specifically, upon receiving the scores S₁, S₂, . . . . S_{N}, the scores may be normalized so the scores to range between values 0 and 1. In an implementation, the distance measure such as the Euclidean distance, may be applied to the scores using the following non-limiting equation:

$$\sqrt[2]{{S}_{1}^{2} + {S}_{2}^{2} + … + {S}_{N}^{2}} \qquad Eqn . ( 1 )$$

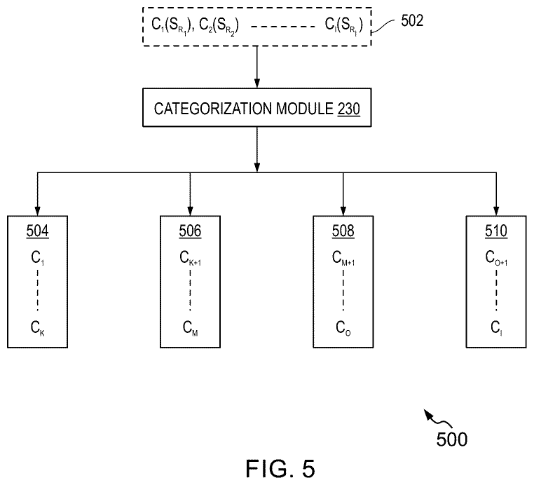

FIG. 5 illustrates a schematic representation of a risk-based categorization operation 500, in accordance with an embodiment of the present disclosure. In a non-limiting implementation, a card candidate set such as C₁, C₂, C₃, . . . . C_{I}, with their respective riskiness scores, such as S_{R}_{₁}, S_{R}_{₂}, S_{R}_{₃}, . . . S_{R}_{ᵢ}, respectively (see, 502) may be considered to explain the risk-based categorization operation 500. Herein, ‘I’ is a non-zero natural number less than N. Further, the risk-based categorization operation 500 is similar to the ‘risk-based categorization’ 314 of FIG. 3. As described earlier, the risk-based categorization operation 500 includes categorizing the payment cards of the card candidate set C₁, C₂, C₃, . . . . C_{I} into the one or more risk categories using the categorization module 232. Herein, upon categorization, a first set of payment cards 504 such as C₁, C₂, C₃, . . . . C_{K}, a second set of payment cards 506 such as C_{K+1}, C₂, C₃, . . . . C_{M}, a third set of payment cards 508 such as C_{M+1}, C₂, C₃, . . . . C_{O}, and a fourth set of payment cards 510 such as C_{O+1}, C₂, C₃, . . . . C_{I} may be obtained. Herein, the K<M<O<I<N. Further, the first set of payment cards 504 belongs to the risk category of ‘very high risky’ 316. The second set of payment cards 506 belongs to the risk category of ‘high risky’ 318. The third set of payment cards 508 belongs to the risk category of ‘medium risky’ 320. The fourth set of payment cards 510 belong to the risk category of ‘low risky’ 322. This categorization is followed by the transactional behavior-based categorization operation 600, as explained above in the present disclosure. Lastly, the recommendation message is generated for each payment card of the card candidate set 308 based on the categories assigned to said payment cards. The recommendation message is then transmitted to the issuer for the issuer to take action as per the recommendation message for fraud prevention.

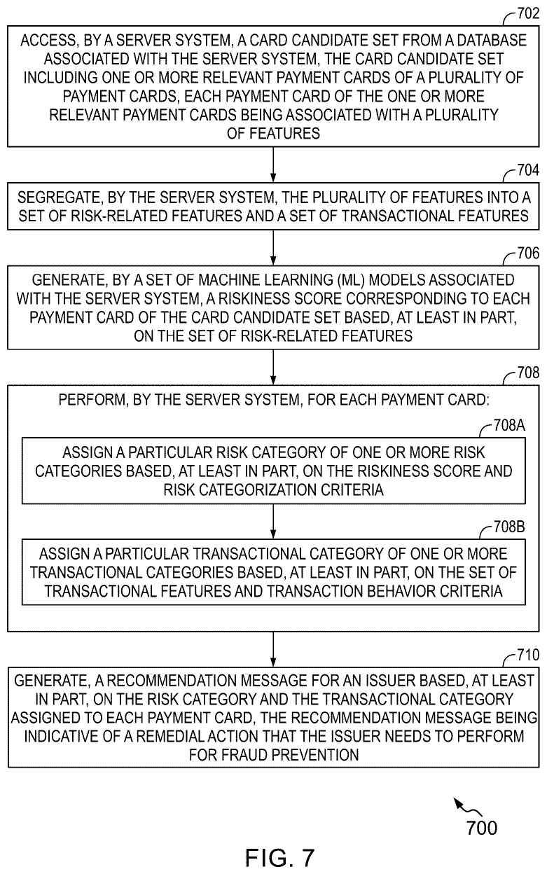

FIG. 7 illustrates a process flow diagram depicting a method 700 for categorizing the one or more payment cards for fraud prevention, in accordance with an embodiment of the present disclosure. The method 700 depicted in the flow diagram may be executed by, for example, the server system 200. The sequence of operations of the method 700 may not necessarily be executed in the same order as they are presented. Further, one or more operations may be grouped and performed in the form of a single step, or one operation may have several sub-steps that may be performed in parallel or in a sequential manner. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at step 702.

At step 702, the method 700 includes accessing, by the server system (e.g., the server system 200), a card candidate set (e.g., the card candidate set 308) from a database (e.g., the database 204) associated with the server system 200. In an embodiment, the card candidate set 308 includes one or more relevant payment cards of a plurality of payment cards (e.g., the payment cards 120). Further, in an embodiment, each payment card of the one or more relevant payment cards is associated with a plurality of features.

At step 704, the method 700 includes segregating, by the server system 200, the plurality of features into a set of risk-related features (e.g., the set of risk-related features 402) and a set of transactional features (e.g., the set of transactional features 602).

At step 706, the method 700 includes generating, by a set of Machine Learning (ML) models (e.g., the ML models 222) associated with the server system 200, a riskiness score (e.g., the riskiness score (S_{R}) 408) corresponding to each payment card based, at least in part, on the set of risk-related features 402.

At step 708, the method 700 includes performing, by the server system 200, for each payment card in steps 708A and 708B.

At step 708A, the method 700 includes assigning a particular risk category of one or more risk categories based, at least in part, on the riskiness score (S_{R}) 408 and risk categorization criteria.

At step 708B, the method 700 includes assigning a particular transactional category of one or more transactional categories based, at least in part, on the set of transactional features 602 and transaction behavior criteria.

At step 710, the method 700 includes generating, by the server system 200, a recommendation message for an issuer based, at least at least in part, on the risk category and the transactional category assigned to each payment card. The recommendation message may be indicative of a remedial action that the issuer needs to perform for fraud prevention.

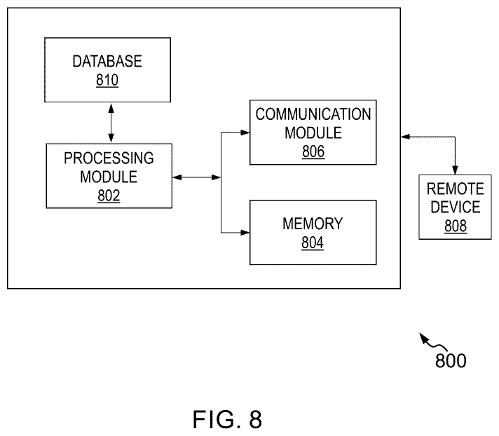

FIG. 8 illustrates a simplified block diagram of a payment server 800, in accordance with an embodiment of the present disclosure. The payment server 800 is an example of the payment server 114 of FIG. 1. The payment server 800 and the server system 200 may use the payment network 112 as a payment interchange network.

The payment server 800 includes a processing module 802 configured to extract programming instructions from a memory 804 to provide various features of the present disclosure. The components of the payment server 800 provided herein may not be exhaustive, and the payment server 800 may include more or fewer components than those depicted in FIG. 8. Further, two or more components may be embodied in one single component, and/or one component may be configured using multiple sub-components to achieve the desired functionalities. Some components of the payment server 800 may be configured using hardware elements, software elements, firmware elements, and/or a combination thereof.

Via a communication module 806, the processing module 802 receives a request from a remote device 808, such as the issuer servers 108, the acquirer servers 110, or the server system 102. The request may be a request for conducting the payment transaction. The communication may be achieved through API calls, without loss of generality. The payment server 800 includes a database 810. The database 810 also includes transaction processing data such as issuer ID, country code, acquirer ID, and merchant identifier (MID), among others.

When the payment server 800 receives a payment transaction request from the acquirer servers 110 or a payment terminal (e.g., IoT device), the payment server 800 may route the payment transaction request to the issuer servers 108. The database 810 stores transaction identifiers for identifying transaction details such as transaction amount, IoT device details, acquirer account information, transaction records, merchant account information, and the like.

In one example embodiment, the acquirer servers 110 is configured to send an authorization request message to the payment server 800. The authorization request message includes, but is not limited to, the payment transaction request.

The processing module 802 further sends the payment transaction request to the issuer servers 108 for facilitating the payment transactions from the remote device 808. The processing module 802 is further configured to notify the remote device 808 of the transaction status in the form of an authorization response message via the communication module 806. The authorization response message includes, but is not limited to, a payment transaction response received from the issuer servers 108. Alternatively, in an embodiment, the processing module 802 is configured to send an authorization response message for declining the payment transaction request, via the communication module 806, to the acquirer servers 110. In an embodiment, the processing module 802 executes similar operations performed by the server system 200, however, for the sake of brevity, these operations are not explained herein.

The disclosed method with reference to FIG. 7, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad scope of the disclosure. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, that are different from those which are disclosed. Therefore, although the disclosure has been described based on these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a card candidate set from a database associated with the server system, the card candidate set comprising one or more relevant payment cards of a plurality of payment cards, each payment card of the one or more relevant payment cards being associated with a plurality of features;
segregating, by the server system, the plurality of features into a set of risk-related features and a set of transactional features;
generating, by a set of Machine Learning (ML) models associated with the server system, a riskiness score corresponding to each payment card of the card candidate set based, at least in part, on the set of risk-related features;
performing, by the server system, for each payment card:
assigning a particular risk category of one or more risk categories based, at least in part, on the riskiness score and risk categorization criteria; and
assigning a particular transactional category of one or more transactional categories based, at least in part, on the set of transactional features and transaction behavior criteria; and
generating, by the server system, a recommendation message for an issuer based, at least in part, on the risk category and the transactional category assigned to each payment card, the recommendation message being indicative of a remedial action that the issuer needs to perform for fraud prevention.

2. The computer-implemented method as claimed in claim 1, wherein generating the riskiness score comprises:
accessing, by the server system, the plurality of risk-related features for each payment card from the database;
generating, by the server system, a training risk feature set for each payment card based, at least in part, on the plurality of risk-related features, wherein the training risk feature set is used to train the set of ML models; and
computing, by the server system, the riskiness score using the set of ML models.

3. The computer-implemented method as claimed in claim 2, wherein training the set of ML models comprises:
accessing, by the server system, the training risk feature set for each payment card from the database;
initializing, by the server system, each ML model of the set of ML models with one or more model parameters for the corresponding ML model; and
performing iteratively, by the set of ML models, for each payment card, until convergence criteria are met, a set of operations comprising:
generating a set of predicted probability scores based, at least in part, on the training risk feature set and the one or more model parameters of the set of corresponding ML models, each ML model generates each predicted probability score of the set of probability scores, and each predicted probability score indicating a likelihood of each payment card being risky;
computing a set of losses based, at least in part, on the set of corresponding probability scores, true labels for the corresponding set of ML models, and a loss function; and
optimizing the one or more model parameters of each ML model of the set of ML models based, at least in part, on back-propagation of the set of losses of the corresponding set of ML models.

4. The computer-implemented method as claimed in claim 3, further comprising:
in response to meeting the convergence criteria, obtaining, by the server system, a set of final predicted probability scores using the set of ML models; and
generating, by the server system, the riskiness score using the set of ML models based, at least in part, on normalizing and performing an ensemble measure on the set of final predicted probability scores.

5. The computer-implemented method as claimed in claim 1, wherein assigning the particular risk category for each payment card comprises:
accessing, by the server system, the riskiness score of each payment card of the card candidate set from the database;
sorting, by the server system, the card candidate set in a predefined order of the riskiness score of each payment card of the card candidate set to obtain a sorted card candidate set; and
segregating, by the server system, the sorted card candidate set into one or more card groups based at least on the riskiness score of each payment card of the sorted card candidate set and a set of grouping thresholds,
wherein each payment card of each card group of the one or more card groups is assigned the particular risk category of the one or more risk categories based at least on the risk categorization criteria.

6. The computer-implemented method as claimed in claim 1, wherein assigning the particular transactional category for each payment card comprises:
accessing, by the server system, the set of transactional features for each payment card of the card candidate set from the database; and
identifying, by the server system, a spending behavior of each payment card of the card candidate set based, at least in part, on the set of transactional features and a set of transactional thresholds,
wherein each payment card of the card candidate set is assigned the particular transactional category of the one or more transactional categories based at least on the spending behavior of the corresponding payment card and the transaction behavior criteria.

7. The computer-implemented method as claimed in claim 1, further comprising:
accessing, by the server system, an input dataset from the database, the input dataset comprising historical information corresponding to a plurality of payment transactions performed between a plurality of cardholders and a plurality of merchants using the plurality of payment cards;
generating, by the server system, the plurality of features for each payment card of the plurality of payment cards based, at least in part, on the input dataset; and
storing, by the server system, the plurality of features in the database.

8. The computer-implemented method as claimed in claim 1, further comprising:
accessing, by the server system, the plurality of features and a set of predetermined risk scores corresponding to each payment card of the plurality of payment cards from the database;
extracting, by the server system, a risky card set from the plurality of payment cards based, at least in part, on the plurality of features, the set of predetermined risk scores, and segregation criteria;
accessing, by the server system, a set of cardholder behavioral attributes associated with each payment card of the risky card set from the database; and
generating, by the server system, the card candidate set based, at least in part, on the risky card set and the set of cardholder behavioral attributes, wherein the card candidate set is a subset of the risky card set.

9. The computer-implemented method as claimed in claim 1, further comprising:
generating, by the server system, a reason code based at least on the risk category and the transactional category assigned to each payment card of the card candidate set, wherein the reason code is indicative of a reason for generating the corresponding recommendation message.

10. The computer-implemented method as claimed in claim 1, wherein the server system is a payment server associated with a payment network.

11. A server system, comprising:
a communication interface;
a memory comprising executable instructions; and
a processor communicably coupled to the communication interface and the memory, the processor configured to cause the server system to at least:
access a card candidate set from a database associated with the server system, the card candidate set comprising one or more relevant payment cards of a plurality of payment cards, each payment card of the one or more relevant payment cards being associated with a plurality of features;
segregate the plurality of features into a set of risk-related features and a set of transactional features;
generate, by a set of Machine Learning (ML) models associated with the server system, a riskiness score corresponding to each payment card of the card candidate set based, at least in part, on the set of risk-related features;
perform for each payment card to:
assign a particular risk category of one or more risk categories based, at least in part, on the riskiness score and risk categorization criteria; and
assign a particular transactional category of one or more transactional categories based, at least in part, on the set of transactional features and transaction behavior criteria; and
generate a recommendation message for an issuer based, at least in part, on the risk category and the transactional category assigned to each payment card, the recommendation message being indicative of a remedial action that the issuer needs to perform for fraud prevention.

12. The server system as claimed in claim 11, wherein to generate the riskiness score, the server system is further caused at least to:
access the plurality of risk-related features for each payment card from the database;
generate a training risk feature set for each payment card based, at least in part, on the plurality of risk-related features, wherein the training risk feature set is used to train the set of ML models; and
compute the riskiness score using the set of ML models.

13. The server system as claimed in claim 12, wherein to train the set of ML models, the server system is further caused at least to:
access the training risk feature set for each payment card from the database;
initialize each ML model of the set of ML models with one or more model parameters for the corresponding ML model; and
perform iteratively, by the set of ML models, for each payment card, until convergence criteria are met, a set of operations comprising:
generating a set of predicted probability scores based, at least in part, on the training risk feature set and the one or more model parameters of the set of corresponding ML models, each ML model generates each predicted probability score of the set of probability scores, and each predicted probability score indicating a likelihood of each payment card being risky;
computing a set of losses based, at least in part, on the set of corresponding probability scores, true labels for the corresponding set of ML models, and a loss function; and
optimizing the one or more model parameters of each ML model of the set of ML models based, at least in part, on back-propagation of the set of losses of the corresponding set of ML models.

14. The server system as claimed in claim 13, wherein the server system is further caused at least to:
in response to meeting the convergence criteria, obtain a set of final predicted probability scores using the set of ML models; and
generate the riskiness score using the set of ML models based, at least in part, on normalizing and performing an ensemble measure on the set of final predicted probability scores.

15. The server system as claimed in claim 11, wherein to assign the particular risk category for each payment card, the server system is further caused at least to:
access the riskiness score of each payment card of the card candidate set from the database;
sort the card candidate set in a predefined order of the riskiness score of each payment card of the card candidate set to obtain a sorted card candidate set; and
segregate the sorted card candidate set into one or more card groups based at least on the riskiness score of each payment card of the sorted card candidate set and a set of grouping thresholds,
wherein each payment card of each card group of the one or more card groups is assigned the particular risk category of the one or more risk categories based at least on the risk categorization criteria.

16. The server system as claimed in claim 11, wherein to assign the particular transactional category for each payment card, the server system is further caused at least to:
access the set of transactional features for each payment card of the card candidate set from the database; and
identify a spending behavior of each payment card of the card candidate set based, at least in part, on the set of transactional features and a set of transactional thresholds,
wherein each payment card of the card candidate set is assigned the particular transactional category of the one or more transactional categories based at least on the spending behavior of the corresponding payment card and the transaction behavior criteria.

17. The server system as claimed in claim 11, wherein the server system is further caused at least to:
access an input dataset from the database, the input dataset comprising historical information corresponding to a plurality of payment transactions performed between a plurality of cardholders and a plurality of merchants using the plurality of payment cards;
generate the plurality of features for each payment card of the plurality of payment cards based, at least in part, on the input dataset; and
store the plurality of features in the database.

18. The server system as claimed in claim 11, wherein the server system is further caused at least to:
access the plurality of features and a set of predetermined risk scores corresponding to each payment card of the plurality of payment cards from the database;
extract a risky card set from the plurality of payment cards based, at least in part, on the plurality of features, the set of predetermined risk scores, and segregation criteria;
access a set of cardholder behavioral attributes associated with each payment card of the risky card set from the database; and
generate the card candidate set based, at least in part, on the risky card set and the set of cardholder behavioral attributes, wherein the card candidate set is a subset of the risky card set.

19. The server system as claimed in claim 11, wherein the server system is further caused at least to generate a reason code based at least on the risk category and the transactional category assigned to each payment card of the card candidate set, wherein the reason code is indicative of a reason for generating the corresponding recommendation message.

20. A non-transitory computer-readable storage medium comprising computer-executable instructions that, when executed by at least a processor of a server system, cause the server system to perform a method comprising:
accessing a card candidate set from a database associated with the server system, the card candidate set comprising one or more relevant payment cards of a plurality of payment cards, each payment card of the one or more relevant payment cards being associated with a plurality of features;
segregating the plurality of features into a set of risk-related features and a set of transactional features;
generating, by a set of Machine Learning (ML) models associated with the server system, a riskiness score corresponding to each payment card of the card candidate set based, at least in part, on the set of risk-related features;
performing for each payment card:
assigning a particular risk category of one or more risk categories based, at least in part, on the riskiness score and risk categorization criteria; and
assigning a particular transactional category of one or more transactional categories based, at least in part, on the set of transactional features and transaction behavior criteria; and
generating a recommendation message for an issuer based, at least in part, on the risk category and the transactional category assigned to each payment card, the recommendation message being indicative of a remedial action that the issuer needs to perform for fraud prevention.
